(19) United States
(12) Patent Application Publication
(10) Pub. No.: US 2022/0015216 A1
(43) Pub. Date: Jan. 13, 2022

(54) Dielectric Isolator Fluid Conveyance

(71) Applicant: Diarmuid Liam O Neill, Bonita Springs, FL (US)

(72) Inventor: Diarmuid Liam O Neill, Bonita Springs, FL (US)

(21) Appl. No.: 16/922,538

(22) Filed: Jul. 7, 2020

(51) Int. Cl. H05F 3/00; H01B 17/00; B64D 45/02

(52) U.S. Cl. CPC H05F 3/00; H01R 4/48; B64D 45/02; H01B 17/005

(57) ABSTRACT

This application is directed to dielectric isolation of fluid conveyance systems both Aerospace and Industrial. The dielectric isolator 5 serves to both prevent high voltage surges transitioning down the conveyance distribution system and second as a means to conduct fluid under pressure. This application address the limitations of current art by approaching the challenge as a pure electrical solution. High resistance precision electrical elements 10 are integrated into a one piece high dielectric material housing 15 which embodies the required end fitting interface. Conductive end collars 20 bonded in position to housing 15 and in contact with resistive elements 10, provides the means for conducting electrical energy to the system interface fitting, coupling or connection. The application provides precision resistance from one unit to the next with built in triple redundancy for high life expectation. The application has the ability to withstand high voltage surge up to 30,000 Volts and by virtue of integrated end ferrules eliminates internal arcing and provides a leak proof design.

### BACKGROUND OF THE INVENTION

This invention relates to dielectric isolation for fluid conveyance systems. More particularly an invention that will serve to control and prevent lightning high voltage surges being transmitted along fuel and or hydraulic systems with ability to detect life performance. This application can be applied to both industrial and aerospace conveyance where low to high voltage surge of 30,000 Volts is a concern.

Aircraft design of the past were fabricated with the use of lightweight aluminum alloys, which provided excellent conductance and shedding of Lightning strike energy through the outer skin of the aircraft to a lower potential ground. With the advent of new aircraft designs, carbon composite have replaced aluminum resulting in a very highly resistive outer skin. The function of dielectric isolators within hydraulic and fuel systems is therefore to make these highly conductive conveyance systems more resistive then the outer composite skin and ground circuit, therefore minimizing the probability of lightning energy puncturing the composite skin to reach these systems and undermine aircraft safety. These dielectric isolators find applications in dry bay areas of the wing but also can be installed in wet bay areas where they lay immersed and surrounded by fuel for most of their operating life. Current art technologies have been found to have limitations due to the nature of their design and fabrication. There are two distinct types of isolators on the market, the first is doped polymer type designs where a conductive fill in a low percentage is mixed into a dielectric polymer. The fillers used vary from carbon powder to chopped fiber to noble metals. These types of isolators have issue in manufacturing as the filler content and where it gathers within the injection molding process is a highly random event. This means each unit shot in the molding process will vary in its electrical performance dramatically within any given lot sample. This technology is also prone to internal arcing within its matrix. When a high differential voltage is applied one conductive fiber or particle will arc internally over to the next. This arc trace then produces a highly conductive path within the matrix until several paths are produced and is why these devices begin to lose their resistivity with each successive high voltage strike. As they lose their resistivity they begin to drop below the specification thresholds. The higher the voltage differential, the bigger the drop in resistance. The second type of isolator uses conductive coatings applied through spray or dip coating. These are more reliable then the former but their integrity is highly reliant on a very chemically resistive base resin and paint chemical formulation. The paint has to withstand in excess of twenty years of fuel immersion including all of the additive chemicals mixed with the fuel to prevent anti-icing, biocides, corrosion inhibitors, and anti static additives. The kerosene fuel and all of its associated additive chemicals slowly over time will be absorbed into the coating and begin to degrade it. The mechanism observed is a slow rise in resistance to the point where it can exceed the upper resistance thresholds. This is safer then the later polymer doped technologies which become less resistive leading to secondary indirect lightning energy to travel and arc down the fuel system. But both change their properties as a function of time and exposure to their environment. Both technologies are highly prone to huge variation in resistance on a lot basis as the process can never be controlled and the size of the tube and the relative surface area and volume it presents also changes the resistance from a small 0.50 inch size tube all the way up to a 4.00 inch size. Prior art performance changes as a function of time but also lot to lot and size to size. Lightning direct and indirect effects is a pure electrical phenomena as such the application described herein solves the issues of prior art as a pure electrical solution. The application submitted takes state of the art high precision electrical resistive elements and embodies them into an integrated system that yields a high precision dielectric isolator with repeatable and reliable performance under all environments. Integrating the end fitting as part of the one piece housing has several benefits of solving the leak path through prior art bonded end fittings, and allows for greater burst pressure while eliminating secondary arcing around the end ferrule. In summary, the application is a highly repeatable fluid conveying dielectric isolator with high precision electrical resistive elements with known failure rates that meet aircraft life expectancy. The precision of the dielectric isolator's resistance allows in service checks and health monitoring of the conveyance system.

### Background Research

Int. Cl.⁴

| | |
|---|---|
| H01B 17/00 | (2006 January) |
| H01C 1/01 | (2006 January) |
| H01C 1/02 | (2006 January) |
| H05F 3/00 | (2006 January) |

U.S. Cl.

174/2; 174/58; 174/137 R; 174/154; 218/102; 218/138; 218/139; 244/1 A; 244/135 R; 361/18; 361/30; 361/215; 361/58; 361/117; 361/126

Field Search

137/554; 137/798; 174/2; 174/58; 174/137 R; 174/154; 218/1; 218/102; 218/138; 218/139; 244/1 A; 244/135 R; 361/18; 361/30; 361/58; 361/117; 361/126; 252/500

### REFERENCES CITED

U.S. Patent Documents

| | | |
|---|---|---|
| 4,630,789 | December 1986 | Rosenburg at al |
| 4,654,747 | March 1987 | Covey |
| 8,003,014 | August 2011 | BrBreay et al |

### BRIEF SUMMARY OF THE INVENTION—DISCLOSURE

In accordance with the present invention which can be applied to both Aerospace and Industrial applications, a system is provided for dielectric isolation for all fluid type conveyance systems. The dielectric isolator consists of three precision electrical resistive elements connected in parallel. An integrated housing made from a high dielectric material such as Peek or any high dielectric material suitable for its surrounding environment and fluid medium. The integrated one-piece housing contains pockets within which the electrical resistive elements are recessed and housed. Contact between all three resistive elements is achieved by their leads wires which are recessed such to make contact with the end collars. Each end collar is bonded to the integrated housing with a conductive bonding adhesive. A high dielectric potting compound is used to cover and pot the resistive elements into the housing. All elements of the invention are considered located and embedded and covered as to provide optimum dielectric high voltage withstanding capability. The one-piece integrated housing provides a leak proof conduit to convey fluid and provides the required end connections to mate with both upstream and downstream system components. Said system is designed to withstand up to 30,000 V which far exceeds current Aerospace standards with static dissipation conducted via the resistive elements embedded within the housing. In another embodiment, a bulkhead type configuration dielectric isolator where a center flange employed allows said invention to be applied as a transition dielectric isolator between storage or holding tanks wet bay to dry bay areas. In another embodiment, a high pressure hydraulic dielectric isolator where the current invention as described is wrapped with reinforcing high dielectric filament winding of glass or Kevlar or other type of non conductive fiber element. Said embodiment and over wrap is added to meet higher system pressure requirements. Said embodiment will incorporate end fittings instead of end ferrules of the type flare-less or flared or female boss suitable for Hydraulic interface. In another embodiment can incorporate any resistance range as required to meet system requirement. In another embodiment can be configured to have one single resistive element or multiple.

### BRIEF DESCRIPTION OF DRAWINGS

In the drawings, like reference numerals are used to designate similar or like parts throughout the drawings. It will be appreciated that the illustrations represent only one of the many boundaries of the invention.

FIG. 1 is an assembly overview illustrating the overall embodiment of the invention.

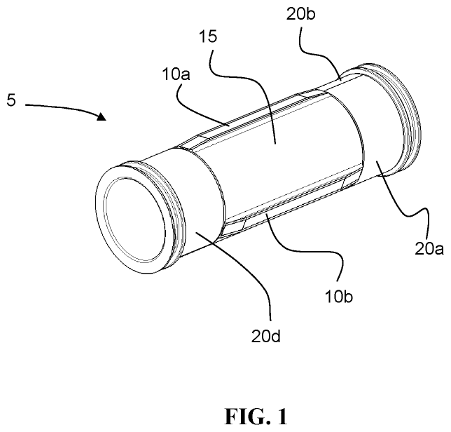

FIG. 2 is a cross section along the axial direction of the dielectric isolator, illustrating connection of electrical resistive elements to end collar.

FIG. 3 is a cross section along the radial direction of the dielectric isolator, illustrating the radial displacement of each of the resistive elements relative to one another.

FIG. 4 is an isometric view of the dielectric isolator illustrating a typical system clam-shell coupling and its bonding springs.

FIG. 5 is an electrical schematic, illustrating the parallel arrangement of electrical resistive elements and relationship to system coupling and ground plane connection.

FIG. 6 illustrates application to a family size of isolators each with identical resistance values.

FIG. 7 illustrates bulkhead center flange type design.

### DETAILED DESCRIPTION OF INVENTION

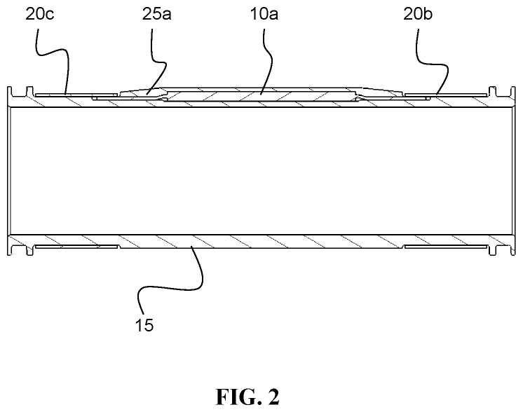

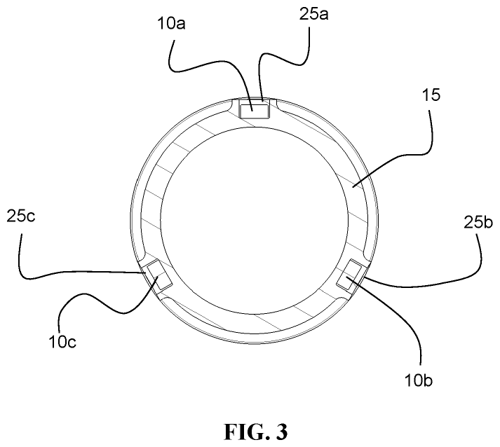

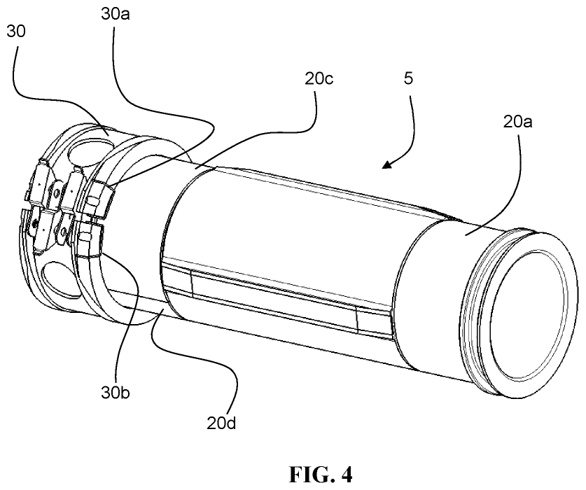

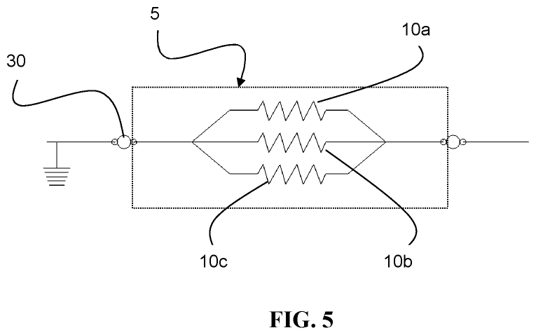

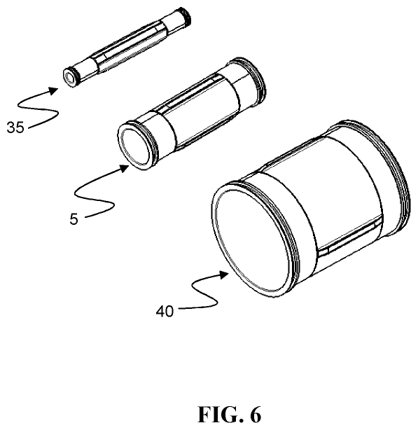

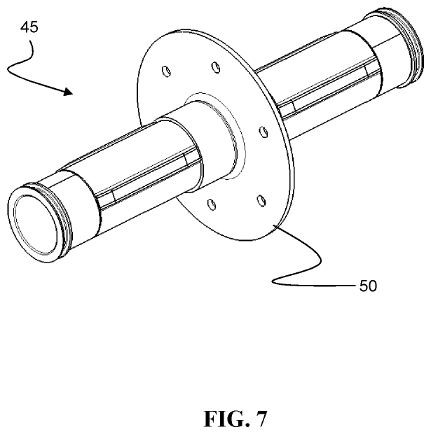

The present application is directed to a dielectric isolator for use in aircraft fuel systems but principle of design can be applied to hydraulic and other Industrial fluid conveyance systems where lightning strike protection is required. With reference to FIG. 2, the dielectric isolator 5 incorporates a one piece housing 15 for the conveyance of fluid and to house the electrical resistive elements 10a, 10b and 10c. It is appreciated and understood the design could contain one resistive element and more than three and is merely dependent on level of redundancy required for the system. The resistive elements 10a, 10b and 10c being contained within their high dielectric body are placed inside the housing 15 pockets formed therein and run axially end to end and their leads terminating under the collar 20a, 20b, 20c and 20d. Collar 20a, 20b, 20c and 20d are bonded to the housing 15 with a conductive adhesive. The collars are fabricated from aluminum alloy or any highly conductive material. With reference to FIG. 3, the electrical resistive elements 10a, 10b and 10c being potted in position with a high dielectric potting compound 25. Dielectric isolator 5, being of such length to provide minimum of three inches of high dielectric surface between conductive ends. FIG. 4 illustrates a typical system fuel coupling 30. Electrical continuity is achieved across a fuel coupling 30 by virtue of its bonding springs 30a. The continuity path through the dielectric isolator 5, is achieved through collars through 20a, 20b electrical resistive elements 10a, 10b, 10c to collars 20c and 20d and to the associated coupling bonding springs 30a, 30b of the opposing end coupling 30. High voltage lightning strike traveling down the fluid system lines is therefore transferred though the coupling 30 into the dielectric isolator 5 and specifically the collars 20 where its transition through the isolator is restricted by the highly resistive electrical elements 10a,10b and 10c. The electrical resistive elements are designed for direct and indirect voltage surges up to 30,000V each. The application allows for choosing the highest resistance thus minimizing energy transferred through the dielectric isolator and downstream of the convenience system. Secondary arcing potential around the end tips of the interface end ferrule is eliminated in this design by virtue of the high dielectric nature of the housing 15 which integrates the end ferrule. FIG. 2 illustrates a 5.4 inch long dielectric isolator; the application can apply to any size and length with the added benefit of each size or length of design having the same identical resistance. FIG. 5 illustrates a three resistive element circuit configuration connected in parallel. This represents a triple redundancy system. The dielectric isolator respects Ohms and Kirchhoffs circuit laws. In the event of loss one electrical resistive element 10a the remaining two resistive elements 10b and 10c will carry the load and increase the overall resistance of the dielectric isolator 5. With the loss of both 10a and 10b the dielectric isolator will default to the maximum circuit resistance which is that of the remaining resistive element 10c. It is therefore noted that with each successive failure—the precise resistance of the dielectric isolator 5 can be measured and determined if a circuit failure has occurred—this is not possible with current art. It is also noted with the failure of each electrical resistive element 10a, 10b and 10c that the isolator becomes a perfect high dielectric isolator, this could be considered a fourth redundancy and safe failure mode. It is noted that each electrical resistive element 10a, 10b and 10c are precision manufactured devices with 1% accuracy or less, meaning the application can have future applications for prognostic health monitoring of the conveyance system dielectric status by either measuring system resistance or having the dielectric isolator 5, self report its status. A technology that is not possible with today's current art. FIG. 2 cross section and FIG. 4 illustrates static dissipation path from housing 15, through collars 20a, 20b electrical resistive elements 10a, 10b, 10c to collars 20c and 20d and to the associated coupling bonding springs 30a, 30b of the opposing end coupling 30. Static charge is also dissipated from housing 15 into electrical resistive elements 10a, 10b, and 10c and dissipated to conductive collars 20a, 20b, 20c and 20d to grounded system conveyance couplings. For the embodiments shown in FIG. 6, illustrates the application being incorporated into a family of isolators each if required being able to have the same end to end electrical resistance measurement. For the embodiment shown in FIG. 7, illustrates how the principal of dielectric isolator 5 can be transcribed into a bulkhead type design 45 with center flange 50.

What is claimed:

1. A fluid carrying dielectric isolator 5 for use in either Industrial or Aerospace fluid conveyance systems where dielectric isolation protection of high voltage lightning strikes are required
a dielectric isolator comprising:
a one piece integrated housing of high dielectric material 15
said housing provides pockets for receiving the electrical resistive elements 10a, 10b and 10c
a means for providing any desired end interface to connect with associated system components
a means to attach conductive collars 20a, 20b, 20c and 20d
a means to retain and encapsulate electrical resistive elements in position with a high dielectric potting compound 25a, 25b and 25c

2. A dielectric isolator 5 in accordance with claim 1, where end to end continuity is provided by location of collars 20a, 20b, 20c and 20d in relation and contact with electrical resistive elements 10a, 10b and 10c.

3. A dielectric isolator in accordance with claim 1, where high voltage is received at either end of the dielectric isolator 5 and is conveyed from system coupling or other system connection into and contacting conductive collars 20a, 20b, 20c and 20d and is current limited by the electric resistive elements 10a, 10b, and 10c with low energy dissipation to opposing end of dielectric Isolator 5 through coupling or other system connection to a lower ground potential.

4. A dielectric isolator 5 in accordance with claim 1, containing high dielectric housing 15 with integrated end ferrule interface, by which eliminating secondary arcing effects within system coupling, with all electrical energy being transferred through bonding springs of system interface coupling.

5. A dielectric Isolator 5 in accordance with claim 1 and by virtue of its integrated end fitting allows for greater wall thickness and as such greater operating and burst pressure rating.

6. A dielectric isolator 5 in accordance with claims 1 and 5, and by virtue of its integrated one piece housing 15 provides a seamless transition of fluid conveyance with no bonded end ferrule thus providing a leak proof design to conduct fluid under pressure.

7. A dielectric isolator 5 in accordance with claim 3, a means to limit electrical current to safe level by the selection of electrical resistive elements 10a, 10b and 10c in the highest range of specification and controlled to very tight tolerance, thus minimizing energy transferred through the isolator

8. A dielectric isolator 5 in accordance with claims 1 and 7 being so designed obeying Ohm's and Kirchhoff's laws having the ability to accurately measure dielectric isolator 5 overall electrical resistance and therefore being able to determine health status and prevent dormant failures.

9. A dielectric isolator 5 in accordance with claim 8, in the event of failure of either one of the resistive elements either 10a, 10b or 10c, the dielectric isolator will continue to function in the advent of one resistive element failure thus obeying Ohm's and Kirchhoff's laws and increasing in isolator resistance.

10. A dielectric isolator 5 in accordance with claims 8 and 9, in the event of failure of two resistive elements either combination of 10a, 10b or 10c, the dielectric isolator 5, will continue to function in the advent of two resistive element failure thus obeying Ohm's and Kirchhoff's laws and increasing in isolator resistance.

11. A dielectric isolator 5 in accordance with claims 8, 9 and 10 being of numerous dielectric isolators distributed in any given conveyance system, allows this system to be easily monitored for dielectric health status and system overall protection and readiness against lightning or high voltage surges.

12. A dielectric Isolator 5 in accordance with claim 1, by virtue of its design can be made to any length required and still maintain any desired or selected resistance level

13. A dielectric Isolator 5 in accordance with claim 1, by virtue of its design can incorporate the same resistive elements through the family size of dielectric isolators and allow all sizes to have and maintain the same resistance irrespective of dielectric isolator size or length.

14. A dielectric Isolator 5 in accordance with claim 1, in this application using three electrical resistive elements for redundancy, understanding this application can be configured with less than two electrical resistive elements and greater than three if so required meeting system specifications

15. A dielectric Isolator 5 in accordance with claims 1, 2, 3, 4, 7, 8, 9, 12, 13 and 14 having precision electrical resistive elements in either singular configuration or multiple present an application capable of operating from 0 through 30,000 volts continuous or transient.

16. A dielectric Isolator 5 in accordance with claims 1, 2, 3, 4, 7, 8, 9, 12, 13 and 14 having precision electrical resistive elements in either singular configuration or multiple present an application capable of operating from 0 volts to the highest value required by system requirements.

17. A dielectric Isolator 5 in accordance with claims 1, 2, 3, 4, 7, 8, 9, 12, 13 and 14 ability to dissipate static electrical charge from housing 15 to end collars 20 through resistive elements 10 to opposing end collars 20 through system coupling or fitting to lower potential ground of adjoining system components
